(19) United States
(12) Patent Application Publication
(10) Pub. No.: US 2026/0331135 A1
(43) Pub. Date: Oct. 22, 2026

(54) MAGNETIC TAPE CARTRIDGE, INFORMATION PROCESSING APPARATUS, INFORMATION PROCESSING METHOD, AND PROGRAM

(71) Applicant: FUJIFILM CORPORATION, Tokyo (JP)

(72) Inventors: Yoichi AKANO, Kanagawa (JP); Toru NAKAO, Kanagawa (JP); Hodaka SUZUKI, Kanagawa (JP)

(21) Appl. No.: 19/730,784

(22) Filed: Jul. 3, 2026

Related U.S. Application Data
(63) Continuation of application No. PCT/JP2025/001451, filed on Jan. 17, 2025.

(30) Foreign Application Priority Data
Feb. 16, 2024 (JP) 2024-022206

(51) Int. Cl. G11B 5/78

(52) U.S. Cl. CPC G11B 5/78

(57) ABSTRACT

A magnetic tape is accommodated in a magnetic tape cartridge. The magnetic tape cartridge includes a storage medium. The storage medium has a storage area in which association information in which a use environment of the magnetic tape and a capability of the magnetic tape, which is a capability usable in the use environment, are associated with each other is storable.

### CROSS-REFERENCE TO RELATED APPLICATIONS

This application is a continuation application of International Application No. PCT/JP2025/001451, filed Jan. 17, 2025, the disclosure of which is incorporated herein by reference in its entirety. Further, this application claims priority from Japanese Patent Application No. 2024-022206, filed Feb. 16, 2024, the disclosure of which is incorporated herein by reference in its entirety.

### BACKGROUND

### 1. Technical Field

The present disclosure relates to a magnetic tape cartridge, an information processing apparatus, an information processing method, and a program.

### 2. Related Art

JP2022-120687A discloses a case that accommodates a magnetic tape and a storage medium provided in the case. A magnetic tape cartridge is disclosed. The storage medium disclosed in JP2022-120687A stores at least one of temperature and humidity tolerance range-related information related to a tolerance range of temperature and humidity during use of the magnetic tape, storage period upper limit-related information related to an upper limit of a storage period of the magnetic tape, or use count upper limit-related information related to an upper limit of the number of times of use of the magnetic tape.

### SUMMARY

One embodiment according to the present disclosure provides a magnetic tape cartridge, an information processing apparatus, an information processing method, and a program that can guarantee recording of data on a magnetic tape and/or reproduction of data from the magnetic tape within a range of a capability suitable for a use environment of the magnetic tape.

According to a first aspect of the present disclosure, there is provided a magnetic tape cartridge that accommodates a magnetic tape, the magnetic tape cartridge comprising:
a storage medium,
in which the storage medium has a storage area capable of storing association information in which a use environment of the magnetic tape is associated with a capability of the magnetic tape, the capability being usable in the use environment.

According to a second aspect of the present disclosure, there is provided the magnetic tape cartridge according to the first aspect,
in which a level of the capability varies depending on the use environment.

According to a third aspect of the present disclosure, there is provided the magnetic tape cartridge according to the first aspect or the second aspect,
in which the capability includes a capacity of the magnetic tape and/or a processing speed at which processing is performed on the magnetic tape.

According to a fourth aspect of the present disclosure, there is provided the magnetic tape cartridge according to any one aspect of the first aspect to the third aspect,
in which first information indicating that the use environment is more important than the capability or second information indicating that the capability is more important than the use environment is assigned to the association information.

According to a fifth aspect of the present disclosure, there is provided the magnetic tape cartridge according to any one aspect of the first aspect to the fourth aspect,
in which the capability includes a plurality of types, and
third information capable of specifying which of the plurality of types is important is assigned to the association information.

According to a sixth aspect of the present disclosure, there is provided the magnetic tape cartridge according to the fifth aspect,
in which the plurality of types include a capacity of the magnetic tape and/or a processing speed at which processing is performed on the magnetic tape.

According to a seventh aspect of the present disclosure, there is provided the magnetic tape cartridge according to any one aspect of the first aspect to the sixth aspect,
in which the use environment is a temperature range and/or a humidity range.

According to an eighth aspect of the present disclosure, there is provided the magnetic tape cartridge according to any one aspect of the first aspect to the seventh aspect,
in which the storage medium is the magnetic tape and/or a noncontact communication medium.

According to a ninth aspect of the present disclosure, there is provided an information processing apparatus comprising:
a processor,
in which in a case where the association information is stored in the storage area of the magnetic tape cartridge according to any one aspect of the first aspect to the eighth aspect, the processor is configured to: acquire the association information from the storage area; and perform specific processing using the association information.

According to a tenth aspect of the present disclosure, there is provided an information processing method, in a case where the association information is stored in the storage area of the magnetic tape cartridge according to any one aspect of the first aspect to the eighth aspect, the method comprising:
acquiring the association information from the storage area; and
performing specific processing using the association information.

According to an eleventh aspect of the present disclosure, there is provided a program for causing a computer to, in a case where the association information is stored in the storage area of the magnetic tape cartridge according to any one aspect of the first aspect to the eighth aspect, execute a process comprising:
acquiring the association information from the storage area; and
performing specific processing using the association information.

### BRIEF DESCRIPTION OF THE DRAWINGS

Exemplary embodiments according to the technique of the present disclosure will be described in detail based on the following figures, wherein:

FIG. 1 is a block diagram showing an example of a configuration of a magnetic tape system;

FIG. 2 is a schematic perspective view showing an example of an appearance of a magnetic tape cartridge;

FIG. 3 is a schematic configuration diagram showing an example of a hardware configuration of a magnetic tape drive;

FIG. 4 is a schematic perspective view showing an example of an aspect in which a magnetic field is emitted by a noncontact read/write device from a lower side of the magnetic tape cartridge;

FIG. 5 is a schematic configuration diagram representing an example of information stored in a cartridge memory;

FIG. 6 is a schematic configuration diagram representing an example of first association information;

FIG. 7 is a schematic configuration diagram representing an example of second association information;

FIG. 8 is a conceptual diagram representing an example of contents of display processing included in the specific processing performed by a processing device;

FIG. 9 is a conceptual diagram representing an example of contents of control processing included in the specific processing performed by the processing device;

FIG. 10 is a flowchart representing an example of a flow of magnetic tape system control processing;

FIG. 11 is a conceptual diagram representing an example of an aspect in which first information or second information is assigned to the first association information;

FIG. 12 is a conceptual diagram representing an example of an aspect in which the first information or the second information is assigned to the second association information;

FIG. 13 is a conceptual diagram representing an example of display processing performed by the processing device in a case where the first information is assigned to the first association information and the second association information;

FIG. 14 is a conceptual diagram representing an example of an aspect in which third information is assigned to the association information;

FIG. 15 is a conceptual diagram representing an example of display processing performed by the processing device in a case where the third information is assigned to the association information;

FIG. 16 is a conceptual diagram representing a first example of automatic control processing performed by the processing device;

FIG. 17 is a conceptual diagram representing a second example of the automatic control processing performed by the processing device;

FIG. 18 is a conceptual diagram representing an example of an aspect in which the association information 50 is stored in the BOT section and/or the EOT section; and

FIG. 19 is a conceptual diagram representing an example of an aspect in which a program stored in a computer-readable and non-transitory storage medium is installed in a computer.

### DETAILED DESCRIPTION

Hereinafter, an example of embodiments of a magnetic tape cartridge, an information processing apparatus, an information processing method, and a program according to the present disclosure will be described with reference to the accompanying drawings.

First, terms used in the following description will be described.

CPU refers to a “Central Processing Unit”. RAM refers to a “Random Access Memory”. NVM refers to a “Non-volatile memory”. EEPROM refers to an “Electrically Erasable and Programmable Read Only Memory”. SSD refers to a “Solid State Drive”. HDD refers to a “Hard Disk Drive”. ASIC refers to an “Application Specific Integrated Circuit”. FPGA refers to a “Field-Programmable Gate Array”. PLC refers to a “Programmable Logic Controller”. SoC refers to a “System on a chip”. IC refers to an “Integrated Circuit”. RFID refers to a “Radio Frequency Identifier”. UI refers to a “User Interface”. WAN refers to a “Wide Area Network”. LAN refers to a “Local Area Network”. EL is an abbreviation for “Electroluminescence”. BOT is an abbreviation for “Beginning Of Tape”. EOT is an abbreviation for “End Of Tape”.

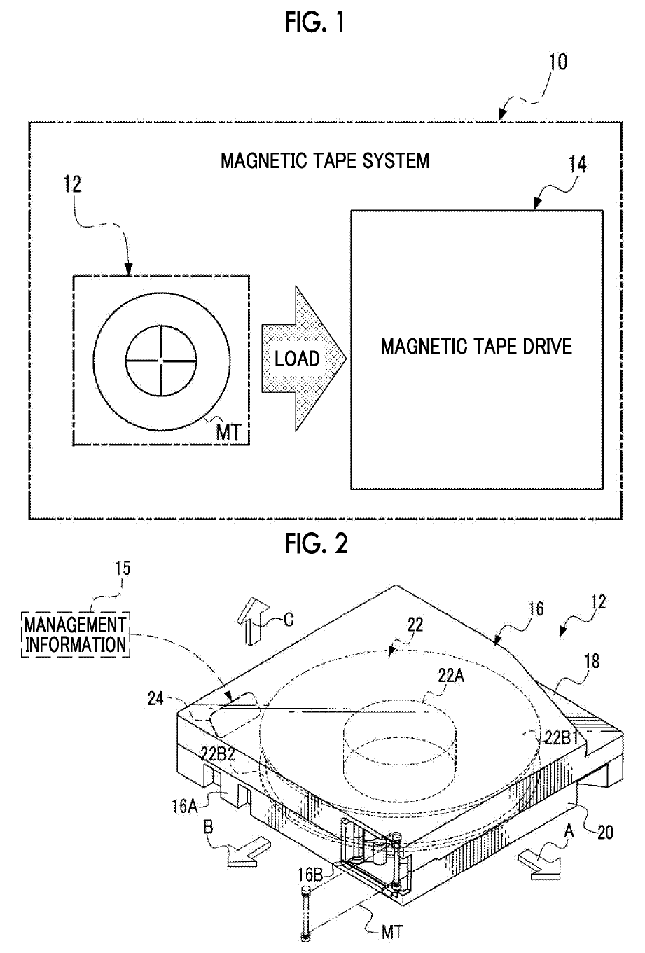

As shown in FIG. 1 as an example, a magnetic tape system 10 comprises a magnetic tape cartridge 12 and a magnetic tape drive 14. The magnetic tape cartridge 12 is loaded into the magnetic tape drive 14. The magnetic tape cartridge 12 accommodates a magnetic tape MT. The magnetic tape drive 14 pulls out the magnetic tape MT from the loaded magnetic tape cartridge 12, and records data on the magnetic tape MT or reads data from the magnetic tape MT while causing the pulled-out magnetic tape MT to travel.

In the present embodiment, the magnetic tape MT is an example of a "magnetic tape" according to the present disclosure. In addition, in the present embodiment, the magnetic tape cartridge 12 is an example of a “magnetic tape cartridge” according to the present disclosure. In addition, in the present embodiment, the magnetic tape drive 14 is an example of an “information processing apparatus” according to the present disclosure.

Next, an example of a configuration of the magnetic tape cartridge 12 will be described with reference to FIGS. 2-4. In the following description, for convenience of description, in FIGS. 2-4, a loading direction of the magnetic tape cartridge 12 into the magnetic tape drive 14 is indicated by an arrow A, a direction of the arrow A is set as a front direction of the magnetic tape cartridge 12, and a side of the magnetic tape cartridge 12 in the front direction is set as a front side of the magnetic tape cartridge 12. In the description of the structure shown below, "front" refers to the front side of the magnetic tape cartridge 12.

In addition, in the following description, for convenience of description, in FIGS. 2-4, a direction of an arrow B1 orthogonal to the direction of the arrow A is referred to as a right direction, and a side in the right direction of the magnetic tape cartridge 12 is referred to as a right side of the magnetic tape cartridge 12. In the description of the structure shown below, "right" refers to the right side of the magnetic tape cartridge 12.

In addition, in the following description, for convenience of description, in FIGS. 2-4, a direction opposite to the direction of the arrow B is set as a left direction, and a side of the magnetic tape cartridge 12 in the left direction is set as a left side of the magnetic tape cartridge 12. In the description of the structure shown below, "left" refers to the left side of the magnetic tape cartridge 12.

In addition, in the following description, for convenience of description, in FIGS. 2-4, a direction orthogonal to the direction of the arrow A and the direction of the arrow B1 is indicated by an arrow C, a direction of the arrow C is referred to as an up direction of the magnetic tape cartridge 12, and a side in the up direction of the magnetic tape cartridge 12 is referred to as an upper side of the magnetic tape cartridge 12. In the description of the structure shown below, "upper" refers to the upper side of the magnetic tape cartridge 12.

In addition, in the following description, for convenience of description, in FIGS. 2-4, a direction opposite to the front direction of the magnetic tape cartridge 12 is set as a rear direction of the magnetic tape cartridge 12, and a side of the magnetic tape cartridge 12 in the rear direction is set as a rear side of the magnetic tape cartridge 12. In the description of the structure shown below, "rear" refers to the rear side of the magnetic tape cartridge 12.

In addition, in the following description, for convenience of description, in FIGS. 2-4, a direction opposite to the upper direction of the magnetic tape cartridge 12 is set as a lower direction of the magnetic tape cartridge 12, and a side of the magnetic tape cartridge 12 in the lower direction is set as a lower side of the magnetic tape cartridge 12. In the description of the structure shown below, "lower" refers to the lower side of the magnetic tape cartridge 12.

As shown in FIG. 2 as an example, the magnetic tape cartridge 12 comprises a substantially rectangular shape in a plan view and includes a box-shaped case 16. The magnetic tape MT is accommodated in the case 16. The case 16 is made of a resin such as polycarbonate, and comprises an upper case 18 and a lower case 20. The upper case 18 and the lower case 20 are joined to each other by welding (for example, ultrasonic welding) and screwing in a state in which a lower peripheral edge surface of the upper case 18 and an upper peripheral edge surface of the lower case 20 are in contact with each other. The joining method is not limited to welding and screwing, and other joining methods may be used.

A supply reel 22 is rotatably accommodated inside the case 16. The supply reel 22 comprises a reel hub 22A, an upper flange 22B1, and a lower flange 22B2. The reel hub 22A is formed in a cylindrical shape. The reel hub 22A is a shaft center portion of the supply reel 22, and a shaft center direction thereof is along an up-down direction of the case 16 and is disposed at a central portion of the case 16. Each of the upper flange 22B1 and the lower flange 22B2 is formed in an annular shape. A central portion of the upper flange 22B1 in a plan view is fixed to an upper end portion of the reel hub 22A, and a central portion of the lower flange 22B2 in a plan view is fixed to a lower end portion of the reel hub 22A. The reel hub 22A and the lower flange 22B2 may be integrally formed.

The magnetic tape MT is wound around an outer peripheral surface of the reel hub 22A, and an end portion of the magnetic tape MT in a width direction is held by the upper flange 22B1 and the lower flange 22B2.

An opening 16B is formed on a front side of a right wall 16A of the case 16. The magnetic tape MT is pulled out from the opening 16B.

The cartridge memory 24 is provided in the lower case 20. Specifically, the cartridge memory 24 is accommodated in a right rear end portion of the lower case 20. The cartridge memory 24 is mounted with an IC chip having an NVM. In the present embodiment, a so-called passive RFID tag is adopted as the cartridge memory 24, and various types of information are read from and written to the cartridge memory 24 in a noncontact manner.

The cartridge memory 24 stores management information 15 for managing the magnetic tape cartridge 12. For example, the management information 15 is stored in the cartridge memory 24 over a plurality of stages. In this case, the management information 15 is stored in the cartridge memory 24 in a manufacturing stage of the magnetic tape cartridge 12, a stage before the magnetic tape cartridge 12 is manufactured, and/or a stage after the magnetic tape cartridge 12 is manufactured. In addition, the entire management information 15 may be stored in the cartridge memory 24 at one time.

The management information 15 includes, for example, information related to the cartridge memory 24 (for example, information for specifying the magnetic tape cartridge 12), information related to the magnetic tape MT, and information related to the magnetic tape drive 14. The information related to the magnetic tape MT refers to, for example, information indicating a transfer rate related to recording of data on the magnetic tape MT and/or reproduction of data from the magnetic tape MT, information indicating a data storage capacity of the magnetic tape MT (hereinafter, also simply referred to as a “capacity”), information indicating an outline of data recorded on the magnetic tape MT, information indicating items of data recorded on the magnetic tape MT, and information indicating a recording format of data recorded on the magnetic tape MT. The information related to the magnetic tape drive 14 refers to, for example, information indicating a specification of the magnetic tape drive 14, a signal used in the magnetic tape drive 14, and the like. In the present embodiment, the cartridge memory 24 is an example of a “storage medium” and a “noncontact communication medium” according to the present disclosure.

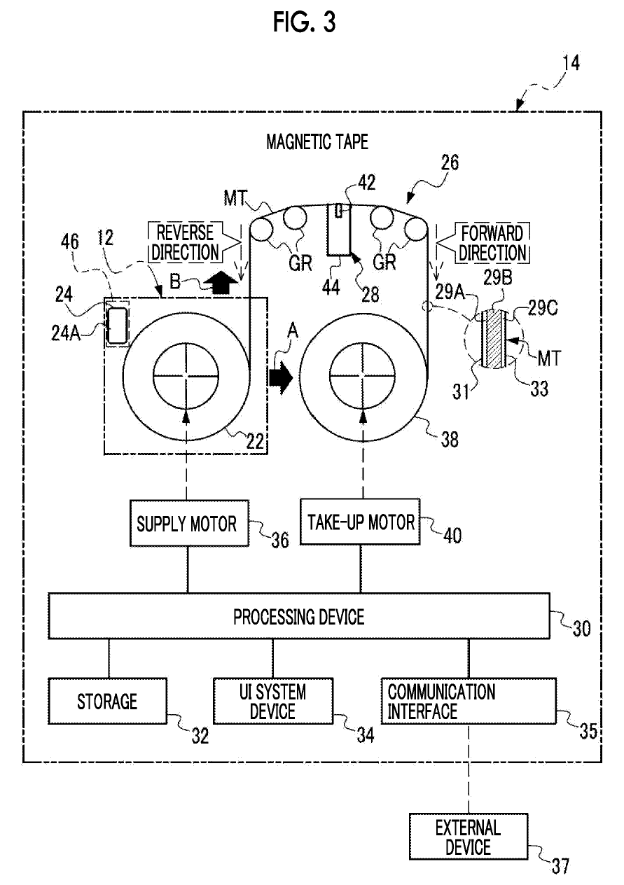

As shown in FIG. 3 as an example, the magnetic tape drive 14 comprises a transport apparatus 26, a magnetic head 28, a processing device 30, a storage 32, a UI system device 34, and a communication interface 35. The magnetic tape cartridge 12 is loaded into the magnetic tape drive 14 along the direction of the arrow A. In the magnetic tape drive 14, the magnetic tape MT is pulled out from the magnetic tape cartridge 12 and used.

The magnetic tape MT has a magnetic layer 29A, a base film 29B, and a back coating layer 29C. The magnetic layer 29A is formed on one surface side of the base film 29B, and the back coating layer 29C is formed on the other surface side of the base film 29B. Data is recorded on the magnetic layer 29A. The magnetic layer 29A contains a ferromagnetic powder. As the ferromagnetic powder, for example, a ferromagnetic powder generally used in a magnetic layer of various magnetic recording media is used. Preferred specific examples of the ferromagnetic powder include a hexagonal ferrite powder. Examples of the hexagonal ferrite powder include a hexagonal strontium ferrite powder and a hexagonal barium ferrite powder. The back coating layer 29C is, for example, a layer containing a non-magnetic powder such as carbon black. The base film 29B is also referred to as a support, and is formed of, for example, polyethylene terephthalate, polyethylene naphthalate, or polyamide. A non-magnetic layer may be formed between the base film 29B and the magnetic layer 29A. In the magnetic tape MT, a surface on which the magnetic layer 29A is formed is a front surface 31 of the magnetic tape MT, and a surface on which the back coating layer 29C is formed is a back surface 33 of the magnetic tape MT.

The magnetic tape drive 14 performs magnetic processing on the front surface 31 of the magnetic tape MT using the magnetic head 28. Here, the magnetic processing refers to recording of data on the front surface 31 of the magnetic tape MT and reading of data from the front surface 31 of the magnetic tape MT (that is, reproduction of data). In the present embodiment, the magnetic tape drive 14 selectively performs the recording of data on the front surface 31 of the magnetic tape MT and the reading of data from the front surface 31 of the magnetic tape MT using the magnetic head 28. That is, the magnetic tape drive 14 pulls out the magnetic tape MT from the magnetic tape cartridge 12, and records data on the front surface 31 of the pulled-out magnetic tape MT using the magnetic head 28 or reads data from the front surface 31 of the pulled-out magnetic tape MT using the magnetic head 28.

The processing device 30 controls the entire magnetic tape drive 14. In the present embodiment, the processing device 30 is implemented by an ASIC, but the present disclosure is not limited thereto. For example, the processing device 30 may be implemented by an FPGA and/or a PLC. In addition, the processing device 30 may be implemented by a computer including a CPU, a flash memory (for example, an EEPROM and/or an SSD), and a RAM. In addition, the processing device 30 may be implemented by a combination of two or more of an ASIC, an FPGA, a PLC, and a computer. That is, the processing device 30 may be implemented by a combination of a hardware configuration and a software configuration. In the present embodiment, the processing device 30 is an example of a "processor" according to the present disclosure.

The storage 32 is connected to the processing device 30, and the processing device 30 writes various types of information to the storage 32 and reads out various types of information from the storage 32. Examples of the storage 32 include a flash memory and/or an HDD. The flash memory and the HDD are merely examples, and any memory may be used as long as it is a non-volatile memory that can be mounted on the magnetic tape drive 14.

The UI system device 34 is a device having a reception function of receiving a command signal indicating a command from a user and a presentation function of presenting information to the user. The reception function is implemented by, for example, a touch panel, a hard key (for example, a keyboard), and/or a mouse. The presentation function is implemented by, for example, a display, a printer, and/or a speaker. The UI system device 34 is connected to the processing device 30. The processing device 30 acquires the command signal received by the UI system device 34. The UI system device 34 presents various types of information to the user under the control of the processing device 30.

The communication interface 35 is connected to the processing device 30. In addition, the communication interface 35 is connected to an external device 37 via a communication network (not shown) such as a WAN and/or a LAN. The communication interface 35 controls the transfer of various types of information (for example, recording data for the magnetic tape MT, data read from the magnetic tape MT, and/or a command signal given to the processing device 30) between the processing device 30 and the external device 37. Examples of the external device 37 include a personal computer, a server, and the like.

The transport apparatus 26 is an apparatus that selectively transports the magnetic tape MT in a forward direction and a reverse direction along a predetermined path, and comprises a supply motor 36, a take-up reel 38, a take-up motor 40, and a plurality of guide rollers GR. Here, the forward direction refers to a feeding direction of the magnetic tape MT, and the reverse direction refers to a rewind direction of the magnetic tape MT.

The supply motor 36 rotates the supply reel 22 in the magnetic tape cartridge 12 under the control of the processing device 30. The processing device 30 controls the rotation direction, the rotational speed, the rotational torque, and the like of the supply reel 22 by controlling the supply motor 36.

The take-up motor 40 rotates the take-up reel 38 under the control of the processing device 30. The processing device 30 controls the rotation direction, the rotational speed, the rotational torque, and the like of the take-up reel 38 by controlling the take-up motor 40.

In a case where the magnetic tape MT is wound around the take-up reel 38, the processing device 30 rotates the supply motor 36 and the take-up motor 40 such that the magnetic tape MT travels in a forward direction along a predetermined path. The rotational speed, the rotational torque, and the like of the supply motor 36 and the take-up motor 40 are adjusted according to a speed at which the magnetic tape MT is wound around the take-up reel 38. In addition, the tension is applied to the magnetic tape MT by adjusting the rotational speed, the rotational torque, and the like of each of the supply motor 36 and the take-up motor 40 by the processing device 30. In addition, the tension applied to the magnetic tape MT is controlled by adjusting the rotational speed, the rotational torque, and the like of each of the supply motor 36 and the take-up motor 40 by the processing device 30.

In a case where the magnetic tape MT is rewound to the supply reel 22, the processing device 30 rotates the supply motor 36 and the take-up motor 40 such that the magnetic tape MT travels in a reverse direction along the predetermined path.

In the present embodiment, the tension applied to the magnetic tape MT is controlled by controlling the rotational speed, the rotational torque, and the like of the supply motor 36 and the take-up motor 40, but the present disclosure is not limited thereto. For example, the tension applied to the magnetic tape MT may be controlled by using a dancer roller, or may be controlled by pulling the magnetic tape MT into a vacuum chamber.

Each of the plurality of guide rollers GR is a roller that guides the magnetic tape MT. The predetermined path, that is, the travel path of the magnetic tape MT is determined by disposing the plurality of guide rollers GR at positions straddling the magnetic head 28 between the magnetic tape cartridge 12 and the take-up reel 38.

The magnetic head 28 comprises a magnetic element unit 42 and a holder 44. The magnetic element unit 42 is held by the holder 44 to be in contact with the magnetic tape MT during traveling. The magnetic element unit 42 has a plurality of magnetic elements.

The magnetic element unit 42 records data on the magnetic tape MT transported by the transport apparatus 26 or reads data from the magnetic tape MT transported by the transport apparatus 26.

The magnetic tape drive 14 comprises a noncontact read/write device 46. The noncontact read/write device 46 is disposed on a lower side of the magnetic tape cartridge 12 in a state in which the magnetic tape cartridge 12 is loaded, to face the back surface 24A of the cartridge memory 24, and reads and writes information from and to the cartridge memory 24 in a noncontact manner.

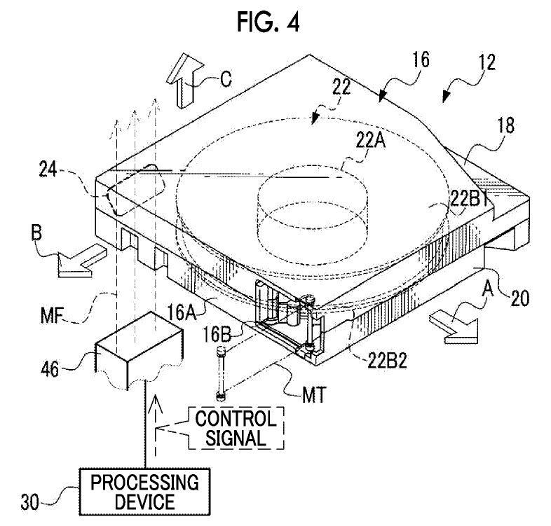

As shown in FIG. 4 as an example, the noncontact read/write device 46 releases a magnetic field MF toward the cartridge memory 24 from a lower side of the magnetic tape cartridge 12. The magnetic field MF penetrates the cartridge memory 24.

The noncontact read/write device 46 is connected to the processing device 30. The processing device 30 outputs a control signal to the noncontact read/write device 46. The control signal is a signal for controlling the cartridge memory 24. The noncontact read/write device 46 generates the magnetic field MF in response to the control signal input from the processing device 30, and releases the generated magnetic field MF toward the cartridge memory 24.

The noncontact read/write device 46 performs processing corresponding to the control signal on the cartridge memory 24 by performing noncontact communication with the cartridge memory 24 via the magnetic field MF. For example, the noncontact read/write device 46 selectively performs processing of reading information from the cartridge memory 24 and processing of storing information in the cartridge memory 24 (that is, processing of writing information to the cartridge memory 24) under the control of the processing device 30.

Meanwhile, in the magnetic tape system 10, the cartridge memory 24 and the magnetic tape MT are configured to store the capacity of the cartridge memory 24, information on the manufacturer, various types of information on the magnetic tape, and the like (for example, JIS X 6175 or ECMA 319). In the 3592 system, the user can optionally determine the capacity of the magnetic tape MT by the combination of the magnetic tape drive 14 and the medium by the media reuse function.

The magnetic tape MT has many advantages as compared with a hard disk and a semiconductor memory. For example, since the magnetic tape MT has a large capacity as compared with a hard disk and a semiconductor memory, a large amount of data (for example, data for backup) can be stored. In addition, since the magnetic tape MT has a longer life as compared with a hard disk and a semiconductor memory, the data can be stored for a long period of time. In addition, since the magnetic tape MT is physically separated from unauthorized access, the security is higher than that of a hard disk and a semiconductor memory. In consideration of such many advantages, it is expected that the demand for the magnetic tape MT is higher than that for a hard disk and a semiconductor memory, particularly as a medium for storing backup data. In this case, for example, it is considered that the magnetic tape system 10 is installed in an existing data center for an HDD instead of the HDD.

It is known that a guaranteed range of temperature and humidity of the HDD (for example, a range of temperature and humidity in which the HDD is guaranteed to function normally) is generally wider than a guaranteed range of temperature and humidity of the magnetic tape MT (for example, a range of temperature and humidity in which the magnetic tape MT is guaranteed to function normally). For example, the guaranteed range of temperature and humidity of the HDD is a range in which the temperature is about 5° C to 50° C and the humidity is about 20 % to 80 %, whereas the guaranteed range of temperature and humidity of the magnetic tape MT is a range in which the temperature is about 10° C to 45° C and the preset humidity is about 20 % to 80 %.

Since the guaranteed ranges of temperature and humidity are different between the HDD and the magnetic tape MT, the magnetic tape system 10 may not be introduced into the existing data center for the HDD. In addition, the constraint of the guaranteed range of temperature and humidity is a factor to be considered when constructing a new data center, and is considered as one of the obstacles to the expansion of the use of the magnetic tape MT. Therefore, for the magnetic tape MT, there is an increasing demand not only for an increase in capacity but also for an expansion of the guaranteed range of temperature and humidity. In addition, there is also a need for an increase in a data transfer rate (hereinafter, simply referred to as a “transfer rate”) related to recording of data on the magnetic tape MT and reproduction of data from the magnetic tape MT.

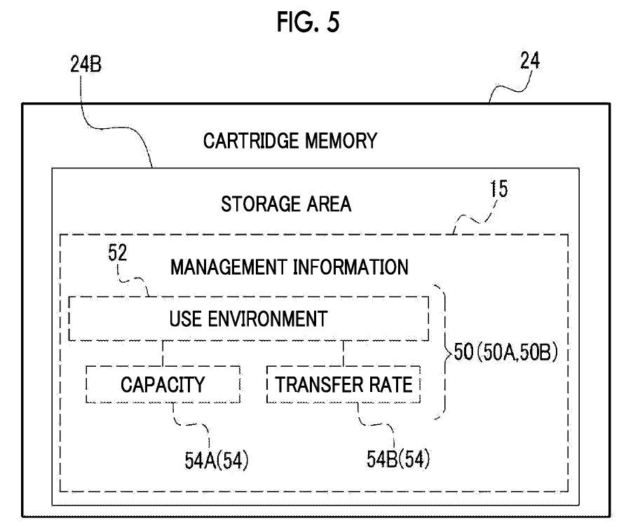

Therefore, in view of such circumstances, in the present embodiment, as shown in FIG. 5 as an example, the association information 50 is included in the management information 15 stored in the cartridge memory 24. The cartridge memory 24 has a storage area 24B in which the management information 15 can be stored. The management information 15 is stored in the storage area 24B. In the example shown in FIG. 5, a form example is shown in which the management information 15 is stored in the storage area 24B, but this is merely an example, and the storage area 24B need only be an area in which the association information 50 included in the management information 15 can be stored. For example, the association information 50 may not be stored in the storage area 24B at the time of manufacturing (or shipment) of the magnetic tape cartridge 12, and the association information 50 may be written in the storage area 24B by the noncontact read/write device 46 or another noncontact read/write device (so-called reader/writer) after the delivery of the magnetic tape cartridge 12 (that is, when the magnetic tape cartridge 12 is used by the user). In addition, the storage area 24B may be a storage area for storing only the association information 50 (that is, a storage area dedicated to the association information 50). In the present embodiment, the “storage area” is an example of a “storage area” according to the present disclosure. In addition, in the present embodiment, the association information 50 is an example of “association information” according to the present disclosure. Hereinafter, an example of a configuration and an application of the association information 50 will be described in detail.

The association information 50 is information in which a use environment 52 of the magnetic tape MT and a capability 54 of the magnetic tape MT are associated with each other. The capability 54 is a capability of the magnetic tape MT, and is a capability that can be used in the use environment 52 (in other words, a capability guaranteed under the use environment 52). In the present embodiment, the use environment 52 is an example of a “use environment” according to the present disclosure, and the capability 54 is an example of a “capability” according to the present disclosure.

The type of the capability 54 is broadly divided into a capacity 54A of the magnetic tape MT and a transfer rate 50B which is an example of a processing speed (for example, a data recording speed and/or a data reproduction speed) for the magnetic tape MT. Therefore, the association information 50 is broadly divided into first association information 50A in which the use environment 52 and the capacity 54A are associated with each other, and second association information 50B in which the use environment 52 and the transfer rate 50B are associated with each other.

In the present embodiment, the capacity 54A and the transfer rate 54B are examples of a “plurality of types” according to the present disclosure, the capacity 54A is an example of a “capacity” according to the present disclosure, and the transfer rate 50B is an example of a “processing speed” according to the present disclosure.

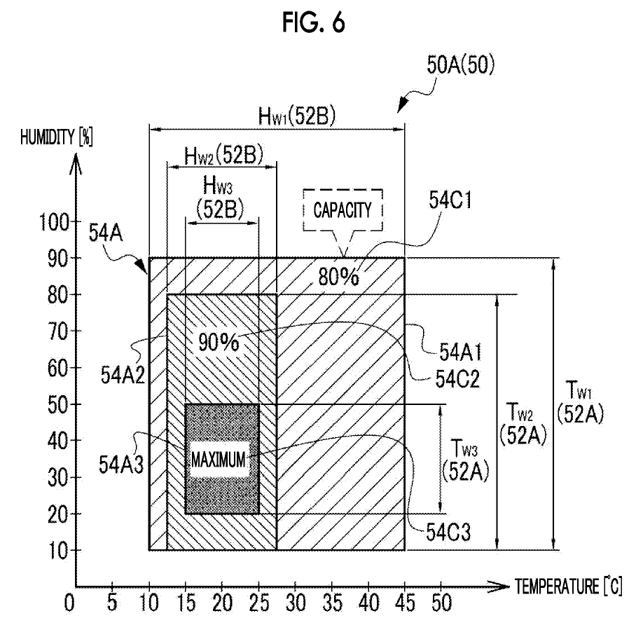

FIG. 6 shows an example of the first association information 50A. As shown in FIG. 6, the use environment 52 is a temperature range 52A and a humidity range 52B. In the example shown in FIG. 6, the capacity 54A is broadly divided into a first capacity 54A1, a second capacity 54A2, and a third capacity 54A3. The first capacity 54A1 is a capacity 54A of a capability level 54C1. The second capacity 54A2 is a capacity 54A of a capability level 54C2. The third capacity 54A3 is a capacity 54A of a capability level 54C3. In the present embodiment, the capability level 54C1, the capability level 54C2, and the capability level 54C3 are examples of a “capability level” according to the present disclosure.

The capability level 54C1, the capability level 54C2, and the capability level 54C3 are different depending on the use environment 52. In the example shown in FIG. 6, 80 % of the capacity 54A in a case where the maximum capacity 54A is 100 % is shown as an example of the capability level 54C1. In addition, in the example shown in FIG. 6, 90 % of the capacity 54A in a case where the maximum capacity 54A is 100 % is shown as an example of the capability level 54C2. Further, in the example shown in FIG. 6, the maximum capacity 54A (that is, 100 % of the capacity 54A) is shown as an example of the capability level 54C3.

A temperature range T_{W1} that is an example of the temperature range 52A and a humidity range H_{W1} that is an example of the humidity range 52B are associated with the first capacity 54A1. That is, the use environment 52 that guarantees the first capacity 54A1 is defined by the temperature range T_{W1} and the humidity range H_{W1}. In addition, a temperature range T_{W2} that is an example of the temperature range 52A and a humidity range H_{W2} that is an example of the humidity range 52B are associated with the second capacity 54A2. That is, the use environment 52 that guarantees the second capacity 54A2 is defined by the temperature range T_{W2} and the humidity range H_{W2}. Further, a temperature range T_{W3} that is an example of the temperature range 52A and a humidity range H_{W3} that is an example of the humidity range 52B are associated with the third capacity 54A3. That is, the use environment 52 that guarantees the third capacity 54A3 is defined by the temperature range T_{W3} and the humidity range H_{W3}.

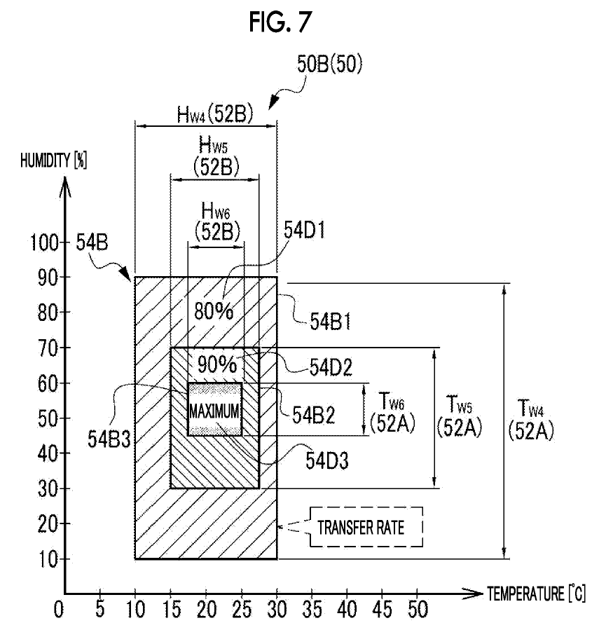

FIG. 7 shows an example of the second association information 50B. In the example shown in FIG. 7, the transfer rate 54B is roughly divided into a first transfer rate 54B1, a second transfer rate 54B2, and a third transfer rate 54B3. The first transfer rate 54B1 is the transfer rate 54B of the capability level 54D1. The second transfer rate 54B2 is the transfer rate 54B of the capability level 54D2. The third transfer rate 54B3 is the transfer rate 54B of the capability level 54D3. In the present embodiment, the capability level 54D1, the capability level 54D2, and the capability level 54D3 are examples of a "capability level" according to the present disclosure.

The capability level 54D1, the capability level 54D2, and the capability level 54D3 are different depending on the use environment 52. In the example shown in FIG. 7, 80 % of the transfer rate 54B in a case where the maximum transfer rate 54B is set to 100 % is shown as an example of the capability level 54D1. In addition, in the example shown in FIG. 7, 90 % of the transfer rate 54B in a case where the maximum transfer rate 54B is set to 100 % is shown as an example of the capability level 54D2. Further, in the example shown in FIG. 7, the maximum of the transfer rate 54B (that is, 100 % of the transfer rate 54B) is shown as an example of the capability level 54D3.

The temperature range T_{W4}, which is an example of the temperature range 52A, and the humidity range H_{W4}, which is an example of the humidity range 52B, are associated with the first transfer rate 54B1. That is, the use environment 52 that guarantees the first transfer rate 54B1 is defined by the temperature range T_{W4} and the humidity range H_{W4}. In addition, the temperature range T_{W5}, which is an example of the temperature range 52A, and the humidity range H_{W5}, which is an example of the humidity range 52B, are associated with the second transfer rate 54B2. That is, the use environment 52 that guarantees the second transfer rate 54B2 is defined by the temperature range T_{W5} and the humidity range H_{W5}. Further, the temperature range T_{W6}, which is an example of the temperature range 52A, and the humidity range H_{W6}, which is an example of the humidity range 52B, are associated with the third transfer rate 54B3. That is, the use environment 52 that guarantees the third transfer rate 54B3 is defined by the temperature range T_{W6} and the humidity range H_{W6}.

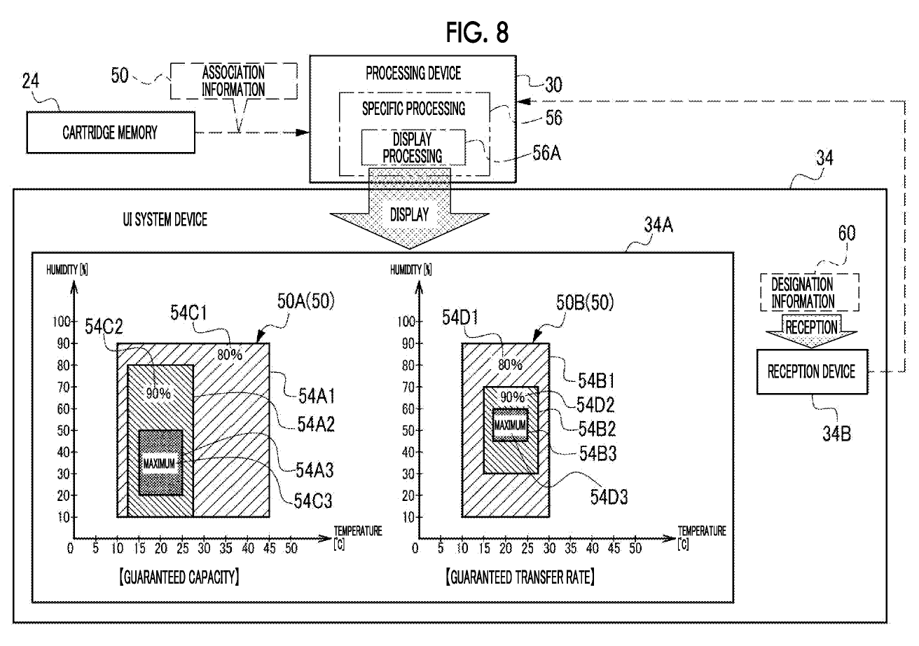

FIG. 8 shows an example of the processing content by the processing device 30 in a case where the magnetic tape cartridge 12 is loaded into the magnetic tape drive 14 (in other words, an example of the use of the association information 50). The processing device 30 acquires the association information 50 included in the management information 15 stored in the cartridge memory 24. Then, the processing device 30 performs specific processing 56 using the association information 50. The specific processing 56 includes display processing 56A. The display processing 56A is processing of performing display based on the association information 50.

The UI system device 34 includes a display 34A and a reception device 34B. Examples of the display 34A include a liquid crystal display or an EL display. Examples of the reception device 34B include a mouse, a keyboard, a soft key, and a dip switch. The processing device 30 performs the display processing 56A to display the first association information 50A and the second association information 50B on the display 34A as visible information. In other words, it can be said that the display processing 56A performed by the processing device 30 is processing of displaying the first association information 50A and the second association information 50B on the display 34A as visible information. In the example shown in FIG. 8, an example is shown in which the first association information 50A and the second association information 50B are graphed and displayed on the display 34A. In the example shown in FIG. 8, a graph in which a horizontal axis is a temperature and a vertical axis is a humidity is shown as a graph showing each of the first association information 50A and the second association information 50B.

Here, although a form example is shown in which the first association information 50A and the second association information 50B are graphed and displayed, the first association information 50A and/or the second association information 50B may be displayed on the display 34A by a figure, a table, a message, a symbol, or the like, the first association information 50A and/or the second association information 50B may be audibly displayed as a voice, or the first association information 50A and/or the second association information 50B may be printed on a medium (for example, paper).

The reception device 34B receives the designation information 60 from a user (hereinafter, simply referred to as a “user”) of the magnetic tape system 10. For example, the user decides the designation information 60 while referring to the first association information 50A and the second association information 50B displayed on the display 34A, and inputs the designation information 60 to the reception device 34B.

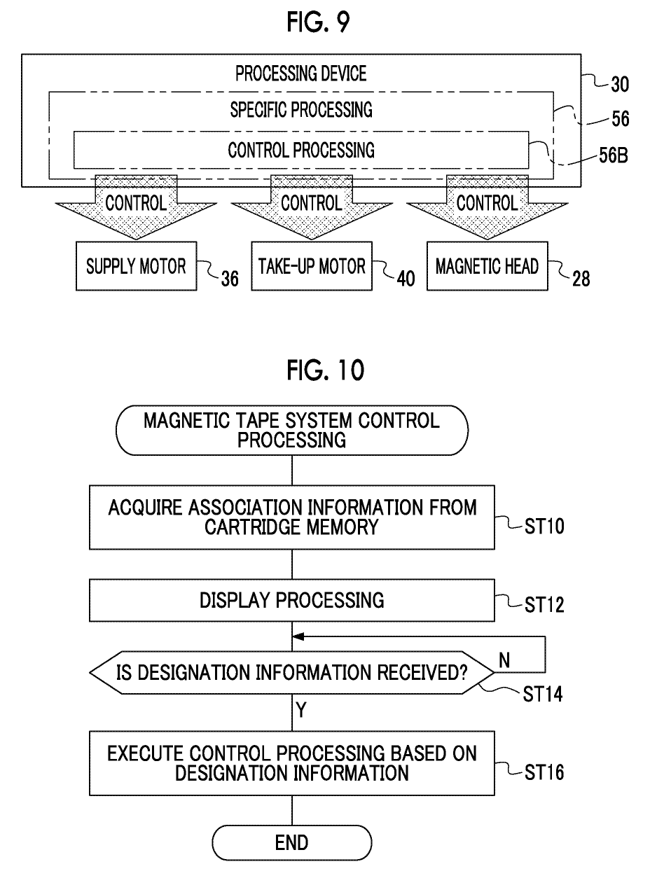

The designation information 60 is information indicating one capacity 54A designated by the user from the first capacity 54A1, the second capacity 54A2, and the third capacity 54A3 included in the first association information 50A, and information indicating one transfer rate 54B designated by the user from the first transfer rate 54B1, the second transfer rate 54B2, and the third transfer rate 54B3 included in the second association information 50B. The processing device 30 performs control processing 56B (see FIG. 9) in accordance with the designation information 60 received by the reception device 34B.

FIG. 9 shows an example of contents of the control processing 56B. The control processing 56B is one of pieces of processing included in the specific processing 56. The processing device 30 performs the control processing 56B to control the supply motor 36, the take-up motor 40, and the magnetic head 28 based on the designation information 60.

The processing device 30 performs the control processing 56B to control the supply motor 36, the take-up motor 40, and the magnetic head 28 such that one capacity 54A (that is, the capacity 54A indicated by the designation information 60) designated by the user is implemented. That is, the processing device 30 controls the supply motor 36, the take-up motor 40, and the magnetic head 28 such that the recording and/or the reproduction of data is performed within a range of the capability levels 54C1, 54C2, or 54C3 of the one capacity 54A designated by the user. As described above, the control processing 56B performed by the processing device 30 includes processing of performing control such that the recording of data on the magnetic tape MT and/or the reproduction of data from the magnetic tape MT is limited to the capacity 54A indicated by the designation information 60 received by the reception device 34B.

In addition, the processing device 30 performs the control processing 56B to control the supply motor 36, the take-up motor 40, and the magnetic head 28 such that one transfer rate 54B (that is, the transfer rate 54B indicated by the designation information 60) designated by the user is implemented. That is, the processing device 30 controls the supply motor 36, the take-up motor 40, and the magnetic head 28 such that data transfer related to the recording and/or the reproduction of data is performed within a range of the capability levels 54D1, 54D2, or 54D3 of the one transfer rate 54B designated by the user. As described above, the control processing 56B performed by the processing device 30 includes processing of performing control such that the data transfer related to the recording of data on the magnetic tape MT and/or the reproduction of data from the magnetic tape MT is limited to the transfer rate 54B indicated by the designation information 60 received by the reception device 34B.

FIG. 10 shows a flowchart showing an example of a flow of the magnetic tape system control processing. The magnetic tape system control processing is executed in a case where the magnetic tape system 10 performs the recording of data on the magnetic tape MT and/or the reproduction of data from the magnetic tape MT. The flow of the magnetic tape system control processing shown in FIG. 10 is an example of an “information processing method” according to the present disclosure. In addition, the magnetic tape system control processing shown in FIG. 10 is an example of a “process” according to the present disclosure.

In the magnetic tape system control processing shown in FIG. 10, first, in step ST10, the processing device 30 acquires the first association information 50A and the second association information 50B from the cartridge memory 24. After the processing of step ST10 is executed, the magnetic tape system control processing proceeds to step ST12.

In step ST12, the processing device 30 executes the display processing 56A based on the first association information 50A and the second association information 50B acquired in step ST10. As a result, the first association information 50A and the second association information 50B are displayed on the display 34A as visible information. After the processing of step ST12 is executed, the magnetic tape system control processing proceeds to step ST14.

In step ST14, the processing device 30 determines whether or not the designation information 60 is received by the reception device 34B. In step ST14, in a case where the designation information 60 is not received by the reception device 34B, a negative determination is made, and the processing of step ST14 is performed again. In step ST14, in a case where the designation information 60 is received by the reception device 34B, a positive determination is made, and the magnetic tape system control processing proceeds to step ST16.

In step ST16, the processing device 30 executes the control processing 56B based on the designation information 60 received by the reception device 34B in step ST14. As a result, the recording of the data on the magnetic tape MT and/or the reproduction of the data from the magnetic tape MT is implemented within the range of the capacity 54A designated by the user and within the range of the transfer rate 54B. After the processing of step ST16 is executed, the magnetic tape system control processing ends.

As described above, in the present embodiment, the association information 50 is stored in the cartridge memory 24. The association information 50 is information in which the use environment 52 and the capability 54 are associated with each other. Therefore, in the present embodiment, the user refers to the association information 50 and provides the designation information 60 to the magnetic tape system 10, so that it is possible to ensure the recording of the data on the magnetic tape MT and/or the reproduction of the data from the magnetic tape MT within the range of the capability of the magnetic tape MT suitable for the actual use environment 52 in which the magnetic tape MT is used.

In addition, in the present embodiment, the capability 54 includes the capacity 54A and the transfer rate 54B. Therefore, it is possible to ensure the recording of the data on the magnetic tape MT and/or the reproduction of the data from the magnetic tape MT within the range of the capacity 54A and the transfer rate 54B of the magnetic tape MT suitable for the actual use environment 52 in which the magnetic tape MT is used.

In addition, in the present embodiment, the use environment 52 is the temperature range 52A and the humidity range 52B. Therefore, it is possible to ensure the recording of the data on the magnetic tape MT and/or the reproduction of the data from the magnetic tape MT within the range of the capacity 54A and the transfer rate 54B of the magnetic tape MT suitable for the actual temperature and humidity at which the magnetic tape MT is used.

In addition, in the present embodiment, the capability level of the capacity 54A is determined for each use environment 52 such that even high-capacity data can be handled. For example, the capability level 54C1 of the first capacity 54A1 (that is, the magnitude of the first capacity 54A1), the capability level 54C2 of the second capacity 54A2 (that is, the magnitude of the second capacity 54A2), and the capability level 54C3 of the third capacity 54A3 (that is, the magnitude of the third capacity 54A3) are made different according to the use environment 52 (for example, the temperature range 52A and the humidity range 52B). Therefore, it is possible to perform the recording of the data on the magnetic tape MT and/or the reproduction of the data from the magnetic tape MT within the range of the capacity 54A of the magnetic tape MT suitable for the actual use environment 52 in which the magnetic tape MT is used, as compared with a case where the magnitude of the capacity 54A is always constant regardless of the use environment 52. As a result, it is possible to ensure the recording of the data on the magnetic tape MT and/or the reproduction of the data from the magnetic tape MT, as compared with a case where the magnitude of the capacity 54A is always constant regardless of the use environment 52. In addition, it is possible to handle even high-capacity data.

In addition, in the present embodiment, the capability level of the transfer rate 54B is determined for each use environment 52 such that even a high transfer rate can be handled. For example, the capability level 54D1 of the first transfer rate 54B1 (that is, the magnitude of the first transfer rate 54B1), the capability level 54D2 of the second transfer rate 54B2 (that is, the magnitude of the second transfer rate 54B2), and the capability level 54D3 of the third transfer rate 54B3 (that is, the magnitude of the third transfer rate 54B3) are made different according to the use environment 52 (for example, the temperature range 52A and the humidity range 52B). Therefore, it is possible to perform the recording of the data on the magnetic tape MT and/or the reproduction of the data from the magnetic tape MT within the range of the transfer rate 54B of the magnetic tape MT suitable for the actual use environment 52 in which the magnetic tape MT is used, as compared with a case where the magnitude of the transfer rate 54B is always constant regardless of the use environment 52. As a result, it is possible to ensure the recording of the data on the magnetic tape MT and/or the reproduction of the data from the magnetic tape MT, as compared with a case where the magnitude of the transfer rate 54B is always constant regardless of the use environment 52. In addition, it is possible to handle even a high transfer rate.

In addition, in the present embodiment, the association information 50 is stored in the cartridge memory 24 mounted on the magnetic tape cartridge 12. Therefore, it is possible to easily ensure the recording of the data on the magnetic tape MT and/or the reproduction of the data from the magnetic tape MT within the range of the capability of the magnetic tape MT suitable for the actual use environment 52 in which the magnetic tape MT accommodated in the magnetic tape cartridge 12 is used.

### Other Modification Examples

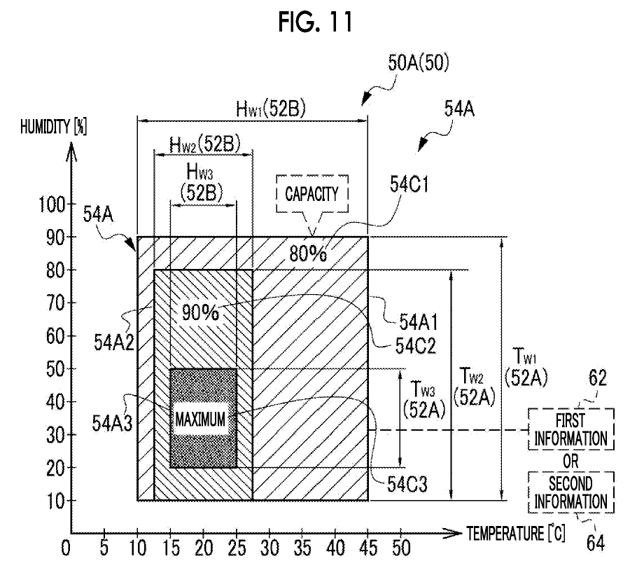

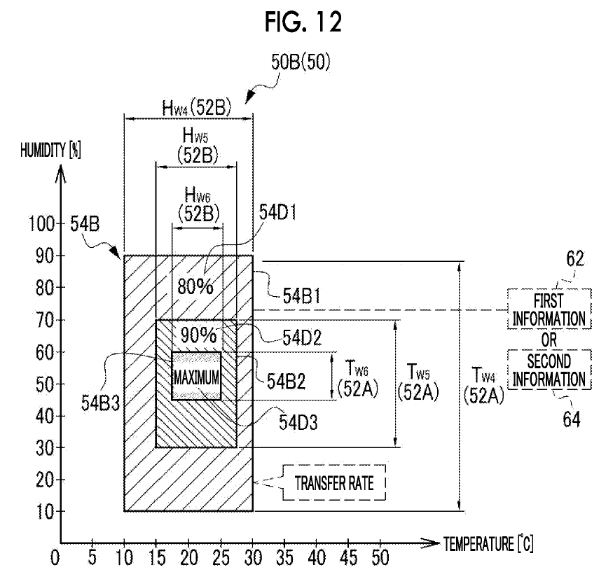

In the above embodiment, the form example has been described in which any of the use environment 52 or the capability 54 is important, but the present disclosure is not limited to this. For example, as shown in FIGS. 11 and 12, the first information 62 indicating that the use environment 52 is more important than the capability 54 or the second information 64 indicating that the capability 54 is more important than the use environment 52 may be assigned to the association information 50. Here, the first information 62 is an example of “first information” according to the present disclosure, and the second information 64 is an example of “second information” according to the present disclosure.

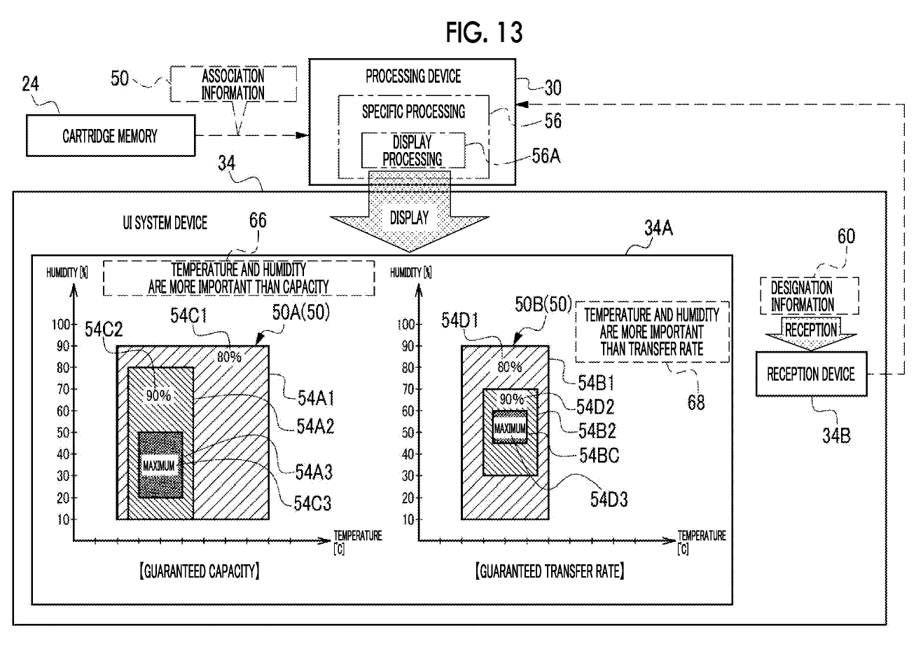

For example, in a case where the first information 62 is assigned to the first association information 50A, as shown in FIG. 13 as an example, the processing device 30 performs the display processing 56A to display, on the display 34A, the visible information 66 (text in the example shown in FIG. 13) indicating that the temperature and humidity, which is an example of the use environment 52, is more important than the capacity 54A, with reference to the first information 62. In addition, for example, in a case where the first information 62 is assigned to the second association information 50B, as shown in FIG. 13 as an example, the processing device 30 performs the display processing 56A to display, on the display 34A, the visible information 68 (text in the example shown in FIG. 13) indicating that the temperature and humidity, which is an example of the use environment 52, is more important than the transfer rate 54B, with reference to the second information 64.

In a case where the display processing 56A is performed in a state in which the second information 64 is assigned to the first association information 50A and in a state in which the second information 64 is assigned to the second association information 50B, the visible information indicating that the temperature and humidity is more important than the capacity 54A is displayed on the display 34A, and the visible information indicating that the temperature and humidity is more important than the transfer rate 54B is displayed on the display 34A.

As described above, by assigning the first information 62 or the second information 64 to the association information 50, the user can understand whether the use environment 52 is more important than the capability 54 or whether the capability 54 is more important than the use environment 52, and thus it is possible to contribute to the improvement of the usability. The assignment of the first information 62 or the second information 64 to the association information 50 does not necessarily need to be displayed to notify the user, and the first information 62 or the second information 64 may be stored in the cartridge memory 24 in a state in which the first information 62 or the second information 64 is associated with the association information 50, and the processing using the first information 62 or the second information 64 stored in the cartridge memory 24 may be executed.

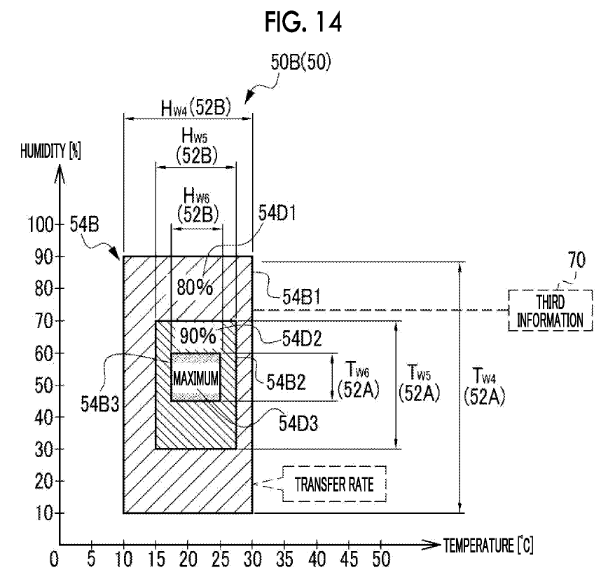

In addition, in the above-described embodiment, the form example has been described in which any one of the capacity 54A or the transfer rate 54B is important, but the present disclosure is not limited to this. For example, in a case where the transfer rate 54B is more important than the capacity 54A, as shown in FIG. 14 as an example, the third information 70 indicating that the transfer rate 54B is more important than the capacity 54A is assigned to the second association information 50B. Here, the third information 70 is an example of "third information" according to the present disclosure.

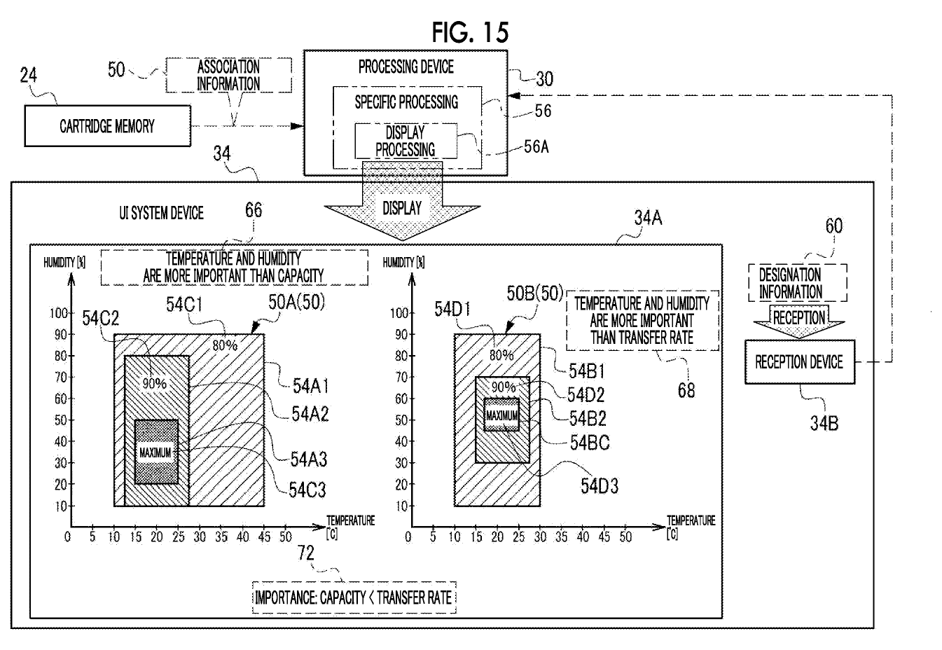

As described above, in a case where the third information 70 is assigned to the second association information 50B, as shown in FIG. 15 as an example, the processing device 30 performs the display processing 56A to display the visible information 72 (in the example shown in FIG. 15, a text) indicating that the transfer rate 54B is more important than the capacity 54A on the display 34A with reference to the third information 70. Here, the visible information 72 has been described as an example, but this is merely an example, and audible information (for example, a voice output from a speaker) indicating that the transfer rate 54B is more important than the capacity 54A may be used.

In the examples shown in FIGS. 14 and 15, the form example in which the third information 70 indicating that the transfer rate 54B is more important than the capacity 54A is assigned to the second association information 50B and the display example on the display 34A in this case have been described, but this is merely an example. Information indicating that the capacity 54A is more important than the transfer rate 54B may be assigned to the first association information 50A. In this case, the visible information indicating that the capacity 54A is more important than the transfer rate 54B is displayed on the display 34A.

As described above, by assigning the information indicating whether any of the capacity 54A or the transfer rate 54B is important to the association information 50, the user can understand whether any of the capacity 54A or the transfer rate 54B is important, which can contribute to the improvement of usability.

In addition, here, the form example has been described in which the information indicating whether any of the capacity 54A or the transfer rate 54B is important is assigned to the first association information 50A or the second association information 50B, but the information indicating whether any of the capacity 54A or the transfer rate 54B is important may be assigned to the association information 50 or to both the first association information 50A and the second association information 50B.

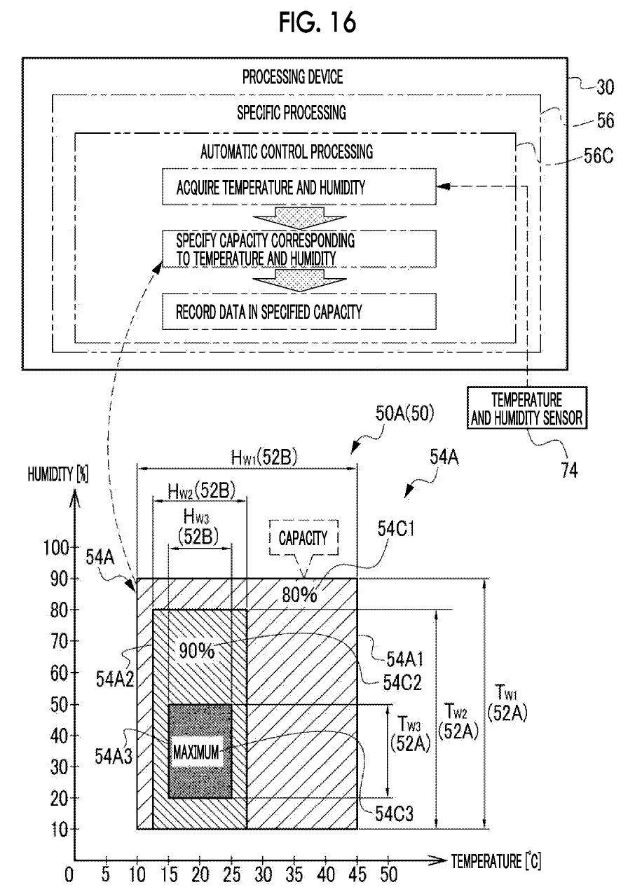

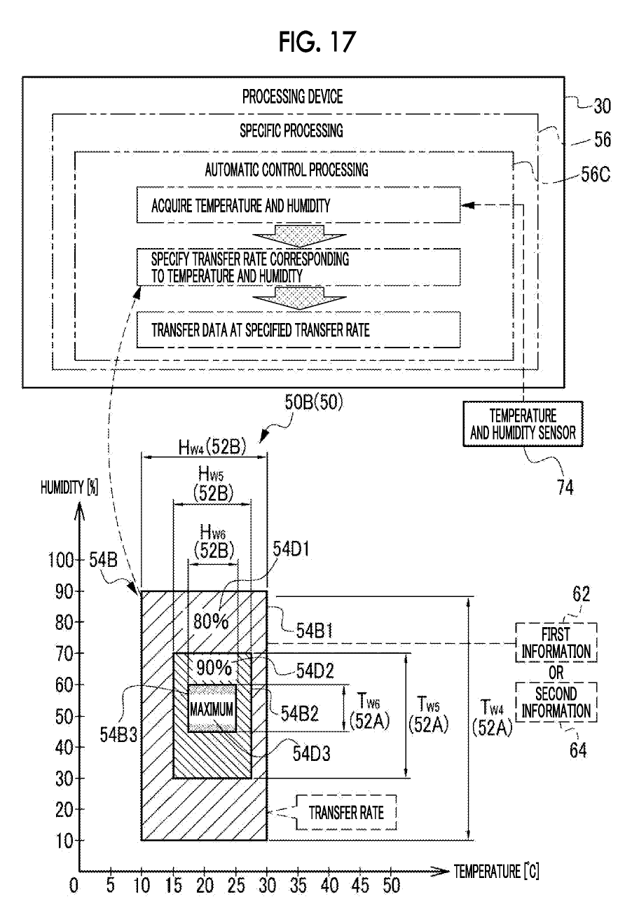

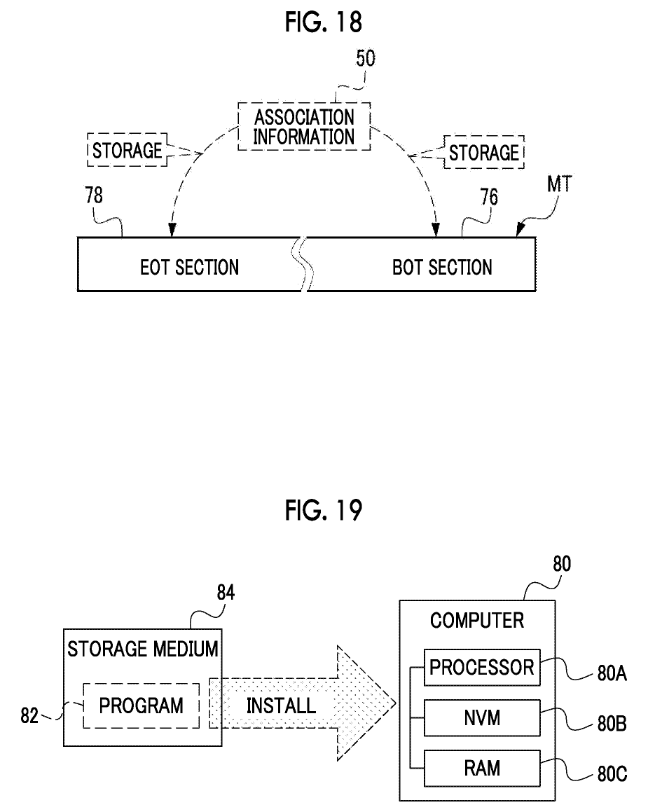

In the embodiment described above, the control processing 56B has been described as an example of one of the pieces of processing included in the specific processing 56, but the present disclosure is not limited to this, and the automatic control processing 56C shown in FIGS. 16 and 17 may be performed by the processing device 30 instead of the control processing 56B or in parallel with the control processing 56B.

As shown in FIGS. 16 and 17, in the magnetic tape system 10, the temperature and humidity sensor 74 is a sensor that actually measures the temperature and the humidity of a place where the magnetic tape system 10 is installed. Examples of the place where the temperature and the humidity are actually measured by the temperature and humidity sensor 74 include a place where the magnetic tape MT is affected by the temperature and the humidity, such as the inside of the housing of the magnetic tape drive 14, the inside of the case 16 of the magnetic tape cartridge 12, or a path on which the magnetic tape MT runs.

In the example shown in FIG. 16, the processing device 30 performs the automatic control processing 56C to execute each of the following first to third steps. In the first step, the processing device 30 acquires the temperature and the humidity actually measured by the temperature and humidity sensor 74 from the temperature and humidity sensor 74. Here, for example, the temperature and the humidity actually measured at one place (for example, the inside of the housing of the magnetic tape drive 14, the inside of the case 16 of the magnetic tape cartridge 12, or a path on which the magnetic tape MT runs) may be acquired by the processing device 30, or statistical values (for example, an average value, a median value, a mode, or a maximum value) of the temperature and the humidity actually measured at a plurality of places (for example, the inside of the housing of the magnetic tape drive 14, the inside of the case 16 of the magnetic tape cartridge 12, and a path on which the magnetic tape MT runs) may be acquired by the processing device 30.

In the second step, the processing device 30 specifies the capacity 54A corresponding to the temperature and the humidity actually measured by the temperature and humidity sensor 74. That is, the processing device 30 specifies the capacity 54A associated with the temperature range 52A and the humidity range 52B including the temperature and the humidity actually measured by the temperature and humidity sensor 74.

Here, in a case where the temperature and the humidity actually measured by the temperature and humidity sensor 74 are included in the plurality of temperature ranges 52A and the plurality of humidity ranges 52B, the processing device 30 specifies the capacity 54A associated with the narrowest temperature range 52A among the plurality of temperature ranges 52A and the narrowest humidity range 52B among the plurality of humidity ranges 52B.

In the third step, the processing device 30 performs the recording of the data on the magnetic tape MT and/or the reproduction of the data from the magnetic tape MT (that is, the transfer of the data) within a range of the capacity 54A specified from the temperature and the humidity actually measured by the temperature and humidity sensor 74 (for example, a maximum value of the capacity 54A specified from the temperature and the humidity actually measured by the temperature and humidity sensor 74).

In the example shown in FIG. 17, the processing device 30 performs the automatic control processing 56C to execute each of the following fourth to sixth steps. In the fourth step, the processing device 30 acquires the temperature and the humidity actually measured by the temperature and humidity sensor 74 from the temperature and humidity sensor 74. In the fifth step, the processing device 30 specifies the transfer rate 54B corresponding to the temperature and the humidity actually measured by the temperature and humidity sensor 74. That is, the processing device 30 specifies the transfer rate 54B associated with the temperature range 52A and the humidity range 52B including the temperature and the humidity actually measured by the temperature and humidity sensor 74.

Here, in a case where the temperature and the humidity actually measured by the temperature and humidity sensor 74 are included in the plurality of temperature ranges 52A and the plurality of humidity ranges 52B, the processing device 30 specifies the transfer rate 54B associated with the narrowest temperature range 52A among the plurality of temperature ranges 52A and the narrowest humidity range 52B among the plurality of humidity ranges 52B.

In the sixth step, the processing device 30 performs the recording of the data on the magnetic tape MT and/or the reproduction of the data from the magnetic tape MT (that is, the transfer of the data) within a range of the transfer rate 54B specified from the temperature and the humidity actually measured by the temperature and humidity sensor 74 (for example, a maximum value of the transfer rate 54B specified from the temperature and the humidity actually measured by the temperature and humidity sensor 74).

Here, as an example of the automatic control processing 56C, an example in which the transfer rate 54B is controlled based on the actually measured temperature and humidity has been described, but this is merely an example, and the capacity 54A may be controlled based on the actually measured temperature and humidity as the automatic control processing 56C in the same manner.

In the above-described embodiment, the form example has been described in which the association information 50 is stored in the cartridge memory 24, but this is merely an example. For example, the association information 50 may be stored in the magnetic tape MT. As an example of a location in which the association information 50 is stored, the association information 50 may be stored in a BOT section 76, which is a section provided at a beginning of the magnetic tape MT, and/or in an EOT section 78, which is a section provided at an end of the magnetic tape MT. As described above, even in a case where the association information 50 is stored in the cartridge memory 24, the same effect as the effect of the above-described embodiment can be expected.

In the above-described embodiment, the first capacity 54A1, the second capacity 54A2, and the third capacity 54A3 are exemplified, and the first transfer rate 54B1, the second transfer rate 54B2, and the third transfer rate 54B3 are exemplified, but this is merely an example. For example, the present disclosure is established even in a case where one (for example, the third capacity 54A3) or two of the first capacity 54A1, the second capacity 54A2, and the third capacity 54A3, and one (for example, the third transfer rate 54B3) or two of the first transfer rate 54B1, the second transfer rate 54B2, and the third transfer rate 54B3 are used. In addition, the number of the capacities 54A may be four or more, and the number of the transfer rates 54B may be four or more.

In the above-described embodiment, the temperature range 52A and the humidity range 52B are exemplified as an example of the use environment 52, but this is merely an example. The use environment 52 may be the temperature range 52A or the humidity range 52B. In addition, the use environment 52 may include various environmental factors capable of specifying an environment in which the magnetic tape MT is used, such as an air volume, weather, and/or an altitude.

In the above-described embodiment, the form example is described in which the designation information 60 is received by the reception device 34B, but this is merely an example. For example, the user may give the designation information 60 to the magnetic tape drive 14 via the external device 37. In addition, the user may monitor the temperature and the humidity actually measured by the temperature and humidity sensor 74 via the external device 37, and give the designation information 60 to the magnetic tape drive 14 in accordance with the monitored temperature and humidity. In addition, the user may monitor the temperature and the humidity actually measured by the temperature and humidity sensor 74 installed in each of the plurality of magnetic tape drives 14 via the external device 37, and give the designation information 60 to each of the plurality of magnetic tape drives 14 in accordance with the monitored temperature and humidity.

In the above-described embodiment, the first association information 50A and the second association information 50B are exemplified, but the present disclosure is established even in a case where any one of the first association information 50A or the second association information 50B is used.

In the above-described embodiment, the magnetic tape system 10 in which the magnetic tape cartridge 12 is insertable into and removable from the magnetic tape drive 14 is exemplified, but the present disclosure is not limited to this. For example, the present disclosure is established even in a magnetic tape system (that is, a magnetic tape system in which at least one magnetic tape cartridge 12 and the magnetic tape drive 14 are integrated in advance) in which at least one magnetic tape cartridge 12 is loaded in advance into the magnetic tape drive 14.

In the above-described embodiment, the processing device 30 implemented by the ASIC is exemplified, but this is merely an example. For example, as shown in FIG. 19, the magnetic tape system control processing shown in FIG. 19 may be executed by using a computer 80 including a processor 80A (for example, a CPU), an NVM 80B, a RAM 80C, and the like, instead of the processing device 30.

In this case, for example, a program 82 may be stored in a computer-readable and non-transitory storage medium 84. Examples of the storage medium 84 include an SSD or a USB memory. The storage medium 84 may be a stationary storage medium or a portable storage medium.

The program 82 stored in the storage medium 84 is installed in the computer 80. The processor 80A executes the magnetic tape system control processing in accordance with the program 82. In the example shown in FIG. 21, the program 82 is an example of a “program” according to the present disclosure, the computer 80 is an example of a “computer” according to the present disclosure, and the processor 80A is an example of a “processor” according to the present disclosure.

In addition, the program 82 may be stored in a storage device of another computer, a server, or the like connected to the computer 80 via a network, and the program 82 may be downloaded in response to a request from the computer 80 and installed in the computer 80.

It is not necessary to store the entire program 82 in a storage device of another computer, a server device, or the like connected to the computer 80, or to store the entire program 82 in the storage 70B, and a part of the program 82 may be stored.

As the hardware resource for executing the magnetic tape system control processing, various processors shown below can be used. Examples of the processor include a CPU which is a general-purpose processor functioning as a hardware resource for executing the magnetic tape system control processing by executing software, that is, a program. In addition, examples of the processor include a dedicated electrical circuit which is a processor having a circuit configuration designed for exclusive use in order to execute specific processing, such as an FPGA, a PLD, or an ASIC. A memory is built in or connected to any of the processors, and any of the processors executes the magnetic tape system control processing by using the memory.

The hardware resource for executing the magnetic tape system control processing may be configured by one of the various processors, or may be configured by a combination of two or more processors of the same type or different types (for example, a combination of a plurality of FPGAs or a combination of a CPU and an FPGA). In addition, the hardware resource for executing the magnetic tape system control processing may be one processor.

As an example of the configuration by one processor, first, there is a form in which one processor is configured by a combination of one or more CPUs and software, and this processor functions as the hardware resource for executing the magnetic tape system control processing. Second, as represented by an SoC or the like, there is a form in which a processor that implements the functions of the entire system including a plurality of hardware resources for executing the magnetic tape system control processing with one IC chip is used. As described above, the magnetic tape system control processing is implemented by using one or more of the various processors as the hardware resource.

More specifically, as the hardware structure of these various processors, an electric circuit in which circuit elements such as semiconductor elements are combined can be used. In addition, the magnetic tape system control processing is merely an example. Therefore, it goes without saying that unnecessary steps may be deleted, new steps may be added, or the processing order may be changed without departing from the gist of the present disclosure.

The contents described and illustrated above are detailed descriptions of the parts according to the present disclosure, and are merely examples of the present disclosure. For example, the above description of the configuration, the function, the operation, and the effect is the description of an example of the configuration, the function, the operation, and the effect of the parts according to the present disclosure. Therefore, it goes without saying that unnecessary parts may be deleted, new elements may be added, or replacements may be made with respect to the contents described and illustrated above within a range that does not deviate from the gist of the present disclosure. In addition, in order to avoid complication and facilitate understanding of the parts according to the present disclosure, the description of common technical knowledge or the like that does not need to be particularly described to enable the implementation of the present disclosure is omitted in the above-described contents and the above-shown contents.

In the present specification, "A and/or B" is synonymous with "at least one of A or B". That is, “A and/or B” means that it may be only A, only B, or a combination of A and B. In addition, in the present specification, the same concept as "A and/or B" is applied to a case where three or more matters are expressed by being connected with "and/or".

In addition, all documents, patent applications, and technical standards described in the present specification are herein incorporated by reference to the same extent that each individual document, patent application, or technical standard was specifically and individually indicated to be incorporated by reference.

What is claimed is:

1. A magnetic tape cartridge that accommodates a magnetic tape, the magnetic tape cartridge comprising:
a storage medium,
wherein the storage medium has a storage area capable of storing association information in which a use environment of the magnetic tape is associated with a capability of the magnetic tape, the capability being usable in the use environment.

2. The magnetic tape cartridge according to claim 1,
wherein a level of the capability varies depending on the use environment.

3. The magnetic tape cartridge according to claim 1,
wherein the capability includes a capacity of the magnetic tape and/or a processing speed at which processing is performed on the magnetic tape.

4. The magnetic tape cartridge according to claim 1,
wherein first information indicating that the use environment is more important than the capability or second information indicating that the capability is more important than the use environment is assigned to the association information.

5. The magnetic tape cartridge according to claim 1,
wherein the capability includes a plurality of types, and
third information capable of specifying which of the plurality of types is important is assigned to the association information.

6. The magnetic tape cartridge according to claim 5,
wherein the plurality of types include a capacity of the magnetic tape and/or a processing speed at which processing is performed on the magnetic tape.

7. The magnetic tape cartridge according to claim 1,
wherein the use environment is a temperature range and/or a humidity range.

8. The magnetic tape cartridge according to claim 1,
wherein the storage medium is the magnetic tape and/or a noncontact communication medium.

9. An information processing apparatus comprising:
a processor,
wherein in a case where the association information is stored in the storage area of the magnetic tape cartridge according to claim 1, the processor is configured to:
acquire the association information from the storage area; and
perform specific processing using the association information.

10. An information processing method, in a case where the association information is stored in the storage area of the magnetic tape cartridge according to claim 1, the method comprising:
acquiring the association information from the storage area; and
performing specific processing using the association information.

11. A non-transitory computer-readable storage medium storing a program executable by a computer to, in a case where the association information is stored in the storage area of the magnetic tape cartridge according to claim 1, execute a process comprising:
acquiring the association information from the storage area; and
performing specific processing using the association information.
